(19) United States
(12) Patent Application Publication
(10) Pub. No.: US 2023/0119297 A1
(43) Pub. Date: Apr. 20, 2023

(54) RECORDING APPARATUS AND METHOD OF CONTROLLING THE SAME

(71) Applicant: CANON KABUSHIKI KAISHA, Tokyo (JP)

(72) Inventor: Kotaro Kimoto, Kanagawa (JP)

(21) Appl. No.: 18/046,105

(22) Filed: Oct. 12, 2022

(30) Foreign Application Priority Data
Oct. 14, 2021 (JP) 2021-169110
Sep. 22, 2022 (JP) 2022-151520

(51) Int. Cl. G01F 23/263

(52) U.S. Cl. CPC G01F 23/268

(57) ABSTRACT

A recording apparatus includes a storage unit, a first electrode, a second electrode, and a circuit. The storage unit stores a liquid or powder to be supplied to a recording portion configured to perform recording. The first electrode is positioned on an outer surface of the storage unit. The second electrode is positioned away from the storage unit. The circuit is connected to each of the first electrode and the second electrode.

### BACKGROUND

### Field

The present disclosure relates to a recording apparatus that detects a storage amount of a content such as a liquid or powder stored in a container, and to a method of controlling the recording apparatus.

### Description of the Related Art

Conventionally, there has been known a method that employs an electrostatic capacitance method to detect a liquid level in a tank, by detecting an electrostatic capacity between a sensor and a liquid stored in the tank using the liquid as a dielectric. In general, the electrostatic capacitance method takes a form in which a sensor is disposed near a container to detect an electrostatic capacity, but in reality, various dielectrics are present near the sensor besides the liquid in the container. Thus, the detected electrostatic capacity can be influenced by the dielectrics, so that the accuracy of detection can be reduced. Japanese Patent No. H06132482 discusses a configuration for increasing the accuracy of detection of an electrostatic capacity by a sensor. In the configuration, a tank is provided with sensors disposed at a plurality of heights corresponding to a plurality of liquid levels in a container, and a liquid level is calculated based on an electrostatic capacitance value at an end of each of the sensors.

However, in the configuration of Japanese Patent No. H06132482, it is necessary to dispose the plurality of sensors on the same tank, and thus the size of the sensors as a whole can increase. Thus, in a case where the size of the tank is limited, each of the sensors needs to be reduced in size and disposed. For this reason, in particular, in a case where the configuration is applied to a small tank, the detection accuracy can be reduced due to a reduction in a detection region of each of the sensors.

### SUMMARY

The present disclosure is directed to improving the accuracy of detection of a storage amount of a content in a container.

According to an aspect of the present disclosure, a recording apparatus includes a storage unit configured to store a liquid or powder to be supplied to a recording portion configured to perform recording, a first electrode positioned on an outer surface of the storage unit, a second electrode positioned away from the storage unit, and a circuit connected to each of the first electrode and the second electrode.

Further features of the present disclosure will become apparent from the following description of exemplary embodiments with reference to the attached drawings.

### BRIEF DESCRIPTION OF THE DRAWINGS

FIG. 1 is a schematic view illustrating an outline of a recording apparatus according to a first exemplary embodiment.

FIG. 2 is a diagram schematically illustrating a circuit configuration of the recording apparatus according to the first exemplary embodiment.

FIG. 3A is a schematic diagram illustrating an ink tank when the ink tank in a state where a sensor substrate is attached thereto is viewed from an X-direction in the first exemplary embodiment, and FIG. 3B is a diagram illustrating the sensor substrate viewed from a Y-direction in the first exemplary embodiment.

FIG. 4 is a graph illustrating a relationship between a remaining ink amount and an electrostatic capacity of a sensor in the first exemplary embodiment.

FIGS. 5A and 5B are conceptual diagrams illustrating the ink tank according to the first exemplary embodiment and components therearound.

FIG. 6 is a graph illustrating a relationship between a remaining ink amount and an electrostatic capacity of the sensor in the first exemplary embodiment.

FIGS. 7A and 7B are conceptual diagrams illustrating a reference sensor and the ink tank according to the first exemplary embodiment, as well as components therearound.

FIG. 8 is a schematic diagram illustrating a configuration of a remaining ink amount detection unit according to the first exemplary embodiment.

FIG. 9 is a flowchart illustrating remaining ink amount detection according to the first exemplary embodiment.

### DESCRIPTION OF THE EMBODIMENTS

A first exemplary embodiment of the present disclosure will be described in detail below with reference to the drawings. A configuration of an inkjet printer serving as an example of a recording apparatus will be described below as a specific example, but the present disclosure is not limited to the configuration of the inkjet printer and is also applicable to an apparatus that detects a storage amount of a content in a container using an electrostatic capacitance method. The present disclosure can also be adopted in an apparatus that contains powder such as toner as the content in the container. The present disclosure is not limited to the inkjet-type recording apparatus, and is also applicable to a recording apparatus of an electrophotographic or other type.

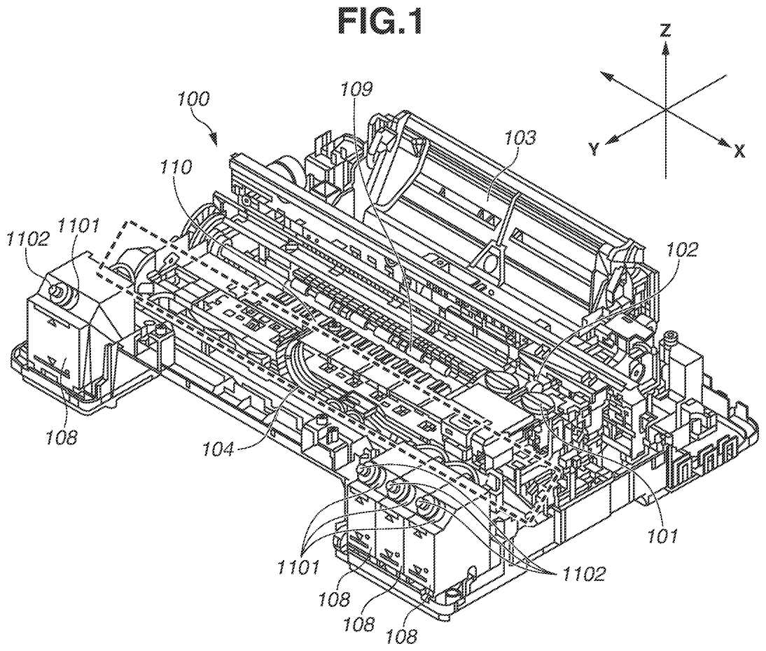

FIG. 1 is a schematic view illustrating an outline of an inkjet recording apparatus. An inkjet recording apparatus 100 (hereinafter referred to as the recording apparatus 100) feeds each of recording media stacked in a sheet feeding tray 103 located at the rear of the recording apparatus 100 using a sheet feeding roller (not illustrated). The fed recording medium is held between a conveyance roller 109 and a pinch roller (not illustrated) that is driven by the conveyance roller 109, and conveyed in a Y-direction in FIG. 1 by rotation of the conveyance roller 109 while being guided to a platen 110 and being supported thereby. The conveyance roller 109 is a metal roller having a surface processed to have minute irregularities so that a large frictional force can be generated. The pinch roller is elastically urged toward the conveyance roller 109 by a pressing member such as a spring (not illustrated).

The platen 110 is disposed at a position facing a recording head 101 serving as a recording portion.

The platen 110 supports the back side of the recording medium to maintain the distance between an ink ejection portion (not illustrated) of the recording head 101 and the front side of the recording medium, i.e., a side facing the ink ejection portion, at a fixed or predetermined distance.

After recording by the recording head 101 is completed, the recording medium conveyed to the platen 110 is held between a discharge roller (not illustrated) and a spur that is a rotational body driven by the discharge roller, and discharged to the outside of the recording apparatus 100. The discharge roller is a rubber roller having a large friction coefficient. The spur is elastically urged toward the discharge roller by a pressing member such as a spring (not illustrated).

The recording head 101 is disposed at a bottom portion of a carriage 102 to face the conveyed recording medium, and includes an ink ejection portion 81 that ejects ink, for each color. The carriage 102 is reciprocated by a driving unit such as a motor in an X-direction (a main scanning direction) along a guide rail 104 disposed at each of upper and lower positions. The X-direction is a direction orthogonal to a conveyance direction (the Y-direction) of the recording medium on a horizontal plane.

The recording head 101 records an image for one band on the recording medium on the platen 110 by ejecting ink drops while moving in the main scanning direction together with the carriage 102. When recording of the image for one band is completed, the recording medium is conveyed by the conveyance roller 109 by a predetermined length in the conveyance direction (intermittent conveyance operation). An image is recorded on the recording medium based on image data by repeating the recording operation for one band and the intermittent conveyance operation.

A plurality of ink tanks 108 independent of each other is fixed to a main unit of the recording apparatus 100, as storage units corresponding to respective colors of ink to be ejected from the recording head 101. Each of the ink tanks 108 and the recording head 101 are connected by a supply tube (not illustrated) corresponding to the color of the ink via a joint (not illustrated). The color ink stored in each of the ink tanks 108 can be thereby individually supplied to the recording head 101 corresponding to each ink color. An ink introduction portion 1101 for supplying ink is disposed at an upper part of each of the ink tanks 108, and the ink introduction portion 1101 is closed with a cap portion 1102. When supplying the ink to the ink tank 108, a user opens the ink introduction portion 1101 by removing the cap portion 1102 from the ink introduction portion 1101, and performs work for supplying the ink.

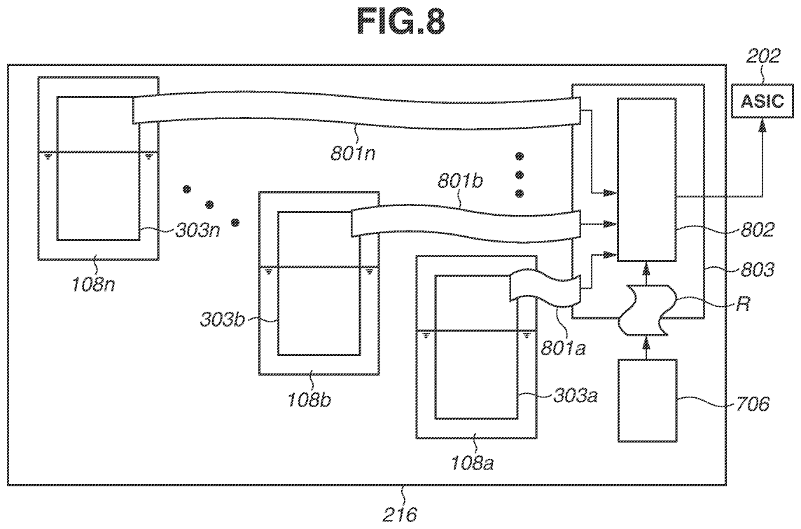

A remaining ink amount detection unit 216 (see FIG. 8) is disposed near the ink tank 108, as a detection unit that detects a remaining amount of ink stored in the ink tank 108.

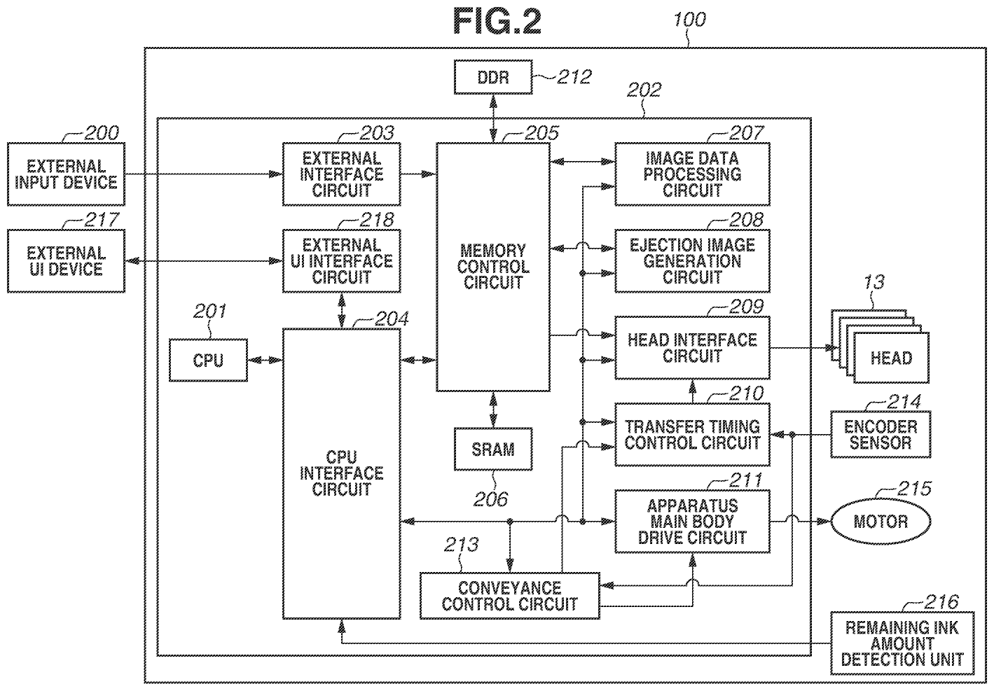

FIG. 2 is a diagram schematically illustrating a circuit configuration of the recording apparatus 100.

The recording apparatus 100 includes a central processing unit (CPU) 201 that controls communication of each block in an application specific integrated circuit (ASIC) 202 via a CPU interface circuit 204 connected to the CPU 201. Processing of image data by the ASIC 202 will be described below.

The recording apparatus 100 receives image data transmitted by an external input device 200, at an external interface circuit 203 connected to the external input device 200. The external interface circuit 203 includes one or more interface circuits connected to the external input device 200, such as a Universal Serial Bus (USB) circuit, a local area network (LAN) interface circuit, and an Integrated Device Electronics (IDE) interface circuit (none of these illustrated). The external interface circuit 203 transfers the received image data to a memory control circuit 205, and the memory control circuit 205 transfers the received image data to a static random access memory (SRAM) 206. The SRAM 206 is a work buffer in which print image data divided into data having a specific size is stored.

As to the number of SRAMs 206, there can be adopted a configuration in which the same number of SRAMs 206 as the number of colors is provided, a configuration in which the same number of SRAMs 206 as the number of nozzles is provided, or the like. Further, as to the SRAM 206, a dynamic RAM (DRAM), a magnetoresistive RAM (MRAM), or the like may be used in place of the SRAM.

A double data rate (DDR) 212 (a memory) is a receiving buffer attached to the ASIC 202, and stores image data processed by an image data processing circuit 207 to be described below. The memory control circuit 205 controls reading and writing of various data from and to the SRAM 206 and the DDR 212.

The image data processing circuit 207 receives image data stored in the SRAM 206 from the memory control circuit 205, and performs image processing thereon. The image processing here refers to processing such as boundary processing, edge processing, horizontal/vertical (HV) conversion, smoothing, and non-ejection interpolation, but other type of processing may be performed. The image data processed in the image data processing circuit 207 is transmitted to an ejection image generation circuit 208 that converts the received image data into ejection image data in a format matching each nozzle of the recording head 101.

A transfer timing control circuit 210 generates a transfer timing signal by multiplying a signal input by an encoder sensor 214, and a head interface circuit 209 transfers the ejection image data to the recording head 101 based on the transfer timing signal.

An apparatus main body drive circuit 211 controls a motor 215 and a head unit lift mechanism (not illustrated) based on operation of a conveyance control circuit 213 under the control of the CPU 201.

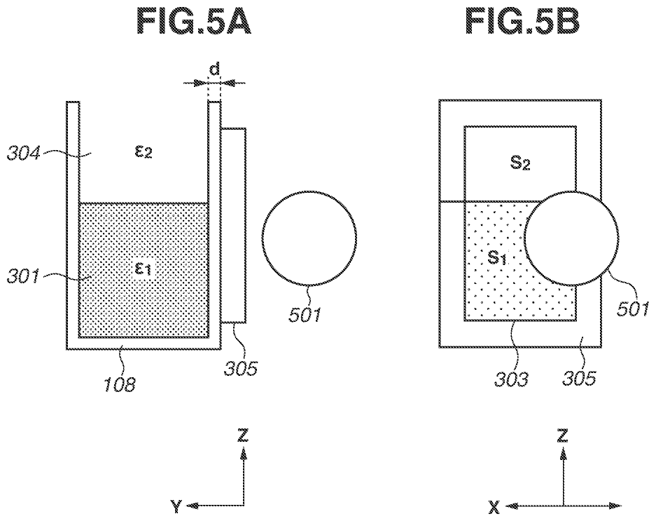

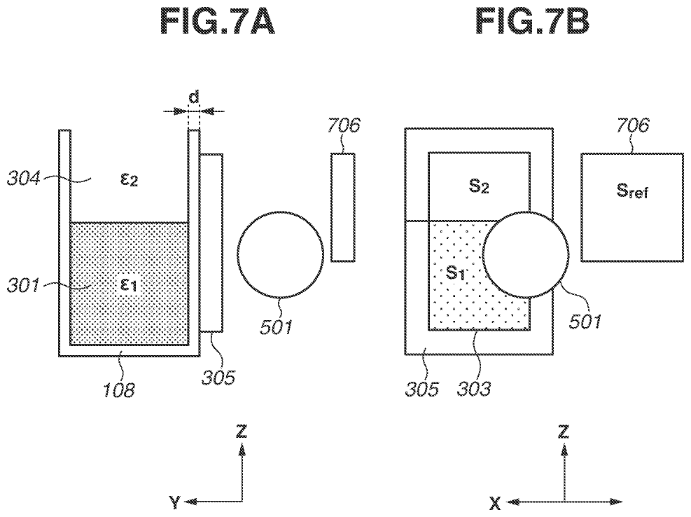

The remaining ink amount detection unit 216 processes a signal acquired from each of a sensor 303 (see FIGS. 5A and 5B) disposed at the ink tank 108 and a reference sensor 706 (see FIGS. 7A and 7B), and transmits the processed signal to the CPU interface circuit 204. The CPU 201 acquires remaining ink amount information about the ink in the ink tank 108 by performing arithmetic processing on information received from the remaining ink amount detection unit 216 via the CPU interface circuit 204.

The recording apparatus 100 further includes an external user interface (UI) device 217 that is a hardware component including units for inputting operations by the user and providing various notifications to the user, such as a panel key, a light emitting diode (LED), and a liquid crystal display (LCD). Information input in the external UI device 217 by the user is converted into data in an external UI interface circuit 218, and the data is transmitted to the CPU interface circuit 204 to be processed in the CPU 201. Conversely, data transmitted from the CPU interface circuit 204 can be converted by the external UI interface circuit 218, so that the external UI device 217 can be driven.

The above-described configuration makes it possible for the recording apparatus 100 to control driving of the external UI device 217 upon acquiring the remaining ink amount information about the ink in the ink tank 108, and notify the user of a remaining ink amount in the ink tank 108.

Information about the configuration of the remaining ink amount detection unit 216 will be described below. For convenience of description, first, the principle of liquid level detection using the electrostatic capacitance method will be described, and then, a configuration related to the exemplary embodiments of the present disclosure will be described.

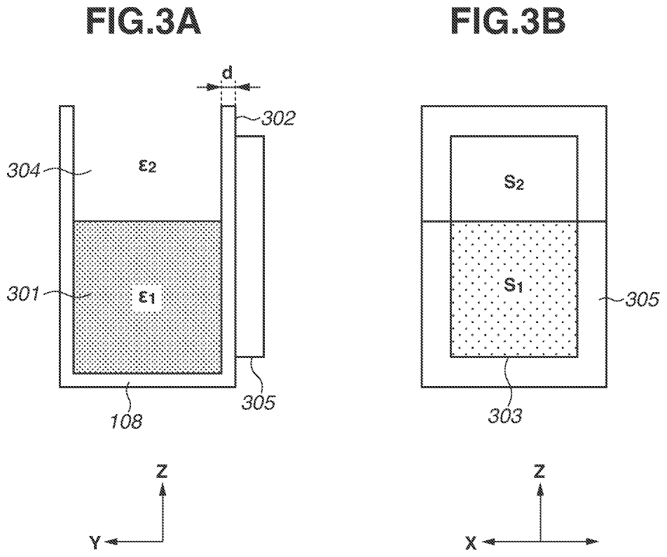

FIG. 3A is a schematic diagram illustrating the ink tank 108 when the ink tank 108 in a state where a sensor substrate 305 is attached thereto is viewed from the X-direction, and FIG. 3B is a diagram illustrating the sensor substrate 305 viewed from the Y-direction. Ink 301 is stored in the ink tank 108, and the sensor substrate 305 is attached in contact with the ink tank 108, specifically, attached to an outer surface 302 forming the ink tank 108. In this state, it is desirable that the sensor substrate 305 tightly adhere to the outer surface 302 of the ink tank 108.

The sensor 303 is located on the sensor substrate 305. The sensor 303 is an electrode, and one or more sensors 303 are disposed on the sensor substrate 305. The sensor substrate 305 is attached to the ink tank 108 as described above, so that the sensor 303 faces the ink 301 and air 304 in the ink tank 108 (in the storage unit) across the outer surface 302.

When the permittivity of the ink 301 is ϵ1, the permittivity of the air 304 is ϵ2, the area of a part facing the ink 301 of the sensor 303 is S1,the area of a part facing the air 304 of the sensor 303 is S2, and the thickness of the ink tank 108 is d, an electrostatic capacity C1 of the sensor 303 can be expressed by Formula 1.

C1=ϵ1(S1/d)+ϵ2(S2/d) (Formula 1)

Where the area of the entire sensor 303 is S, S=S1+S2 is established. Thus, Formula 1 can be further expressed as Formula 2.

C1=ϵ1(ϵ1−ϵ2)*(S1/d)+ϵ2(S/d) (Formula 2)

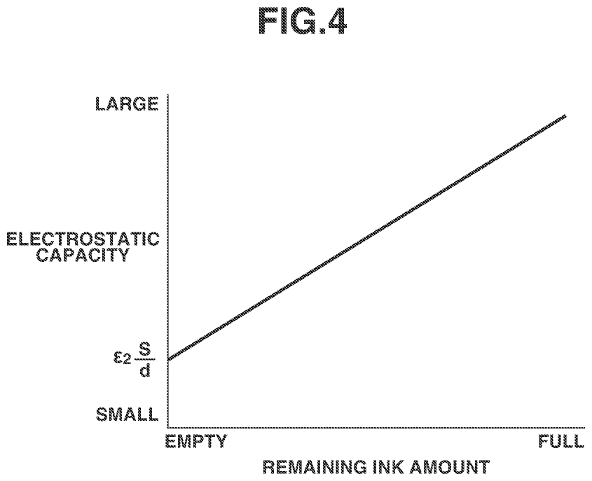

FIG. 4 is a graph illustrating the relationship between the remaining ink amount and the electrostatic capacity C1 of the sensor 303. Because S1 in Formula 2 described above is the area of the part facing the ink 301 of the sensor 303, the remaining ink amount in the ink tank 108 and S1 are proportional to each other. Thus, the electrostatic capacity C1 expressed by Formula 2 is also proportional to the remaining ink amount in the ink tank 108 as illustrated in the graph in FIG. 4. However, in reality, dielectrics other than the ink 301 and the air 304 in the ink tank 108 are present near the sensor 303, and thus an offset occurs in a detection value of the electrostatic capacity.

FIGS. 5A and 5B are conceptual diagrams illustrating the ink tank 108 and components therearound. FIG. 5A is a conceptual diagram illustrating the ink tank 108 viewed from the X-direction, and FIG. 5B is a conceptual diagram illustrating the ink tank 108 viewed from the Y-direction. Here, a dielectric 501 other than the ink 301 and the air 304 in the ink tank 108 is conceptually illustrated as one circle, but in general, a plurality of dielectrics 501 is present near the ink tank 108, and does not necessarily have a shape. Examples of the dielectric 501 include a machinery portion and a conducting wire portion (not illustrated) disposed on the sensor substrate 305, and components (not illustrated) disposed near the sensor 303 in the recording apparatus 100. Further, moisture in the air around the ink tank 108 also acts as the dielectric 501.

In particular, the moisture in the air acting as the dielectric 501 has a large influence on the electrostatic capacity C1 of the sensor 303. Besides the moisture contained in the air around the ink tank 108, condensation can occur depending on the relationship between the temperatures of the above-described machinery portion, conducting wire portion, and components, and the temperature and humidity of the air, and the condensation can act as the dielectric 501. In other words, the electrostatic capacity C1 of the sensor 303 is influenced by the humidity and the temperature around the ink tank 108. In addition, in a case where the materials of the machinery portion and the conducting wire portion of the sensor substrate 305 have moisture absorbency, the higher the moisture absorbency is, the more the electrostatic capacity C1 is influenced.

Here, where an electrostatic capacity caused by the dielectric 501 with respect to the sensor 303 is Cex, an electrostatic capacity C2 of the sensor 303 in a state where an offset has occurred by the dielectric 501 is expressed as Formula 3.

C1=ϵ1(ϵ1−ϵ2)*(S1/d)+ϵ2(S2/d)+Cex (Formula 2)

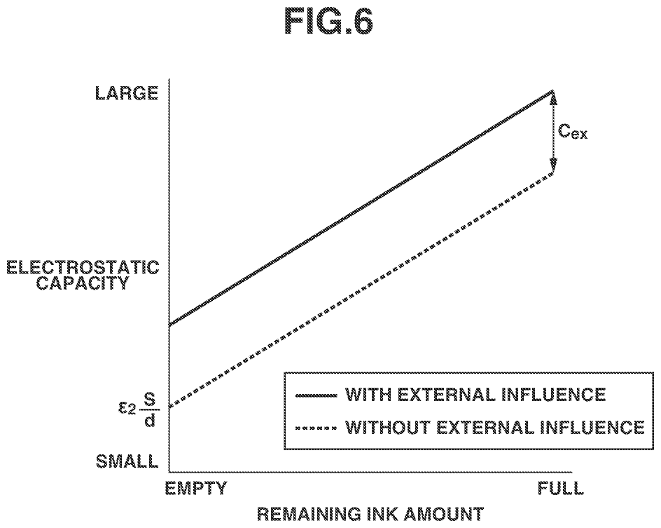

A graph illustrated in FIG. 6 represents a relationship between the remaining ink amount and the electrostatic capacity C2 of the sensor 303 according to Formula 3. In this case, an offset has occurred in the electrostatic capacity C2 by Cex with respect to the electrostatic capacity C1 in the case where the dielectric 501 is not present. Thus, this is a state where the remaining ink amount in the ink tank 108 cannot be correctly detected.

FIGS. 7A and 7B are conceptual diagrams illustrating the reference sensor 706 and the ink tank 108, as well as components therearound. FIG. 7A is a conceptual diagram illustrating the ink tank 108 viewed from the X-direction, and FIG. 7B is a conceptual diagram illustrating the ink tank 108 viewed from the Y-direction. The recording apparatus 100 according to the present exemplary embodiment includes the reference sensor 706 to be used as a reference separately from the sensor 303. As with the sensor 303, one or more reference sensors 706 are disposed on a sensor substrate (not illustrated) and away from the ink tank 108. The sensor substrate on which the reference sensor 706 is disposed may be part of a substrate for another component, or may be an independent substrate including only the reference sensor 706.

The reference sensor 706 is separated by a distance long enough to avoid the influence of the ink 301 and the air 304 in the ink tank 108, and an electrostatic capacity Cref of the reference sensor 706 is not influenced by an increase and decrease of an amount of ink in the ink tank 108. However, since the dielectric 501 is present near the reference sensor 706, the electrostatic capacity Cref is influenced by the dielectric 501.

In general, the longer the distance between a sensor and a dielectric is, the less the electrostatic capacity of the sensor is influenced by the dielectric. Thus, the longer the distance between the reference sensor 706 and the ink tank 108 is, the less the electrostatic capacity Cref is influenced by the ink 301. However, in the present exemplary embodiment, as described above, the electrostatic capacity Cref of the reference sensor 706 is used to correct the electrostatic capacity C2 of the sensor 303 disposed on the outer surface 302 of the ink tank 108, as will be described below. Thus, it is desirable to have a state where an environment of a position at which the reference sensor 706 is disposed and an environment of a position at which the sensor 303 is disposed are close.

Here, as described above, the plurality of dielectrics 501 is present near the ink tank 108. Thus, if the reference sensor 706 and the sensor 303 are excessively away from each other, the state of the dielectric 501 present near the reference sensor 706 and the state of the dielectric 501 present near the sensor 303 can be different.

For example, in a case where the moisture in the air around the ink tank 108 is considered as the dielectric 501, if the position of the reference sensor 706 and the position of the sensor 303 are excessively away from each other, humidity at the respective positions can be different. In such a case, an influence on the reference sensor 706 by the dielectric 501 and an influence on the sensor 303 by the dielectric 501 are different, and thus there is a possibility that the electrostatic capacity C2 of the sensor 303 cannot be appropriately corrected. Thus, it is desirable to dispose the reference sensor 706 so that the state of the dielectric 501 that influences the reference sensor 706 and the state of the dielectric 501 that influences the sensor 303 are close.

In addition, the electrostatic capacity Cref of the reference sensor 706 can be influenced by an environment outside the recording apparatus 100. Thus, it is desirable that the reference sensor 706 be disposed at a position not in proximity to an outer surface of the recording apparatus 100. For example, in a case where the ink tank 108 is disposed on the frontward side of the recording apparatus 100 in the Y-direction as illustrated in FIG. 1, it is desirable that the reference sensor 706 be disposed on the back face side (the rear face side), not on the front face side of the ink tank 108, in the Y-direction. The reference sensor 706 and the sensor 303 may not face each other, and may be disposed to have an intersecting or skew relationship.

Where the electrode area of the reference sensor 706 is Sref, the electrostatic capacity Cref detected by the reference sensor 706 can be expressed as Formula 4.

Cref=Cex(Sref/S) (Formula 4)

Here, transforming Formula 4 about Cex results in Formula 5. Further, Formula 6 is obtained by subtracting Cex in Formula 5 from Formula 3 expressing the electrostatic capacity C2 of the sensor 303 in the state where the offset has occurred.

Cex=Cref(S/Sref) (Formula 5)

C2−Cex=(ϵ1−ϵ2)(S1/d)+c2 (S2/d)+Cex — Cref(S/Sref)=(ϵ1−ϵ2)(S1/d)+ϵ2(S2/d)+Cex−Cex=(ϵ1−ϵ2)(S1/d)+ϵ2(S2/d)=C1 (Formula 6)

As described above, the value of the electrostatic capacity C2 is corrected by subtracting the electrostatic capacity Cref of the reference sensor 706 from the electrostatic capacity C2 of the sensor 303 in the state where the offset has occurred. The electrostatic capacity C1 based on the amount of the ink 301 in the ink tank 108 in the state where there is no offset by the dielectric 501 is thereby determined.

FIG. 8 is a schematic diagram illustrating a configuration of the remaining ink amount detection unit 216. Sensors 303a to 303n are attached to outer surfaces 302 of the n-number of ink tanks 108a to 108n. The reference sensor 706 is disposed at a position away from all the ink tanks 108a to 108n. The sensors 303a to 303n may be disposed on the same sensor substrate 305, or may be disposed on respective separate sensor substrates.

An electrostatic capacity detection substrate 803 including an electrostatic capacity detection circuit 802, and each of the sensors 303a to 303n are connected via conducting wires 801a to 801n. The reference sensor 706 and the electrostatic capacity detection substrate 803 are connected via a conducting wire R. The electrostatic capacity C2 is detected in the electrostatic capacity detection circuit 802 via the conducting wire 801 (the conducting wires 801a to 801n) as detection information of the sensor 303. The electrostatic capacity Cref is detected in the electrostatic capacity detection circuit 802 via the conducting wire R as detection information of the reference sensor 706. The electrostatic capacities C2 and Cref detected in the electrostatic capacity detection circuit 802 are each converted into an electric signal in the electrostatic capacity detection circuit 802, and the electric signal is input in the ASIC 202. Subsequently, electrostatic capacity correction processing is performed in the ASIC 202 based on information about each of the input electrostatic capacities.

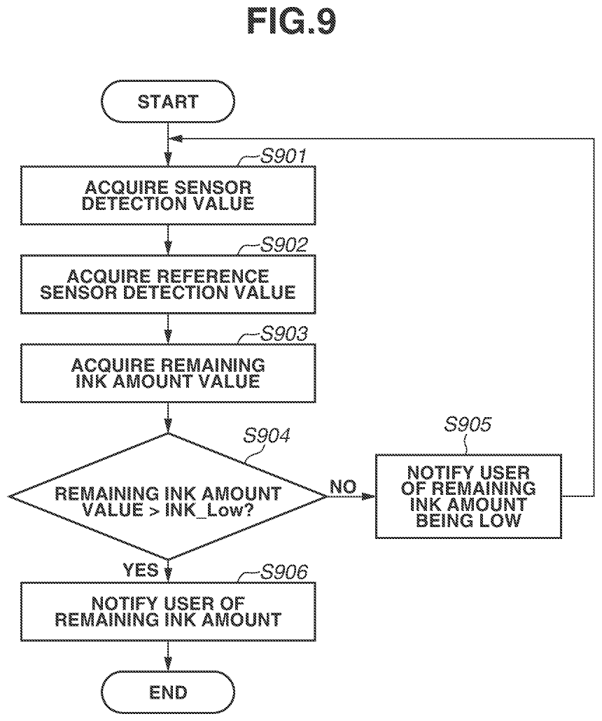

FIG. 9 is a flowchart illustrating remaining ink amount detection in the present exemplary embodiment. Here, remaining ink amount detection processing performed on one ink tank 108 will be described. However, in a case where the recording apparatus 100 includes the plurality of ink tanks 108 as illustrated in FIG. 1, the processing in the flowchart is performed on each of the ink tanks 108.

When the remaining ink amount detection processing is started, first, in step S901, the electrostatic capacity detection circuit 802 in the remaining ink amount detection unit 216 converts the electrostatic capacity C2 in the sensor 303 into an electric signal, and inputs the electric signal to the ASIC 202 as a detection value. Next, in step S902, in a manner similar to step S901, the electrostatic capacity detection circuit 802 in the remaining ink amount detection unit 216 converts the electrostatic capacity Cref in the reference sensor 706 into an electric signal, and inputs the electric signal to the ASIC 202 as a detection value.

Subsequently, in step S903, the ASIC 202 performs the arithmetic processing using the electrostatic capacity C2 of the sensor 303 and the electrostatic capacity Cref of the reference sensor 706 input to the ASIC 202. The ASIC 202 performs the arithmetic processing according to the correction formula expressed as Formula 6. A value obtained by the arithmetic processing is a remaining ink amount value.

In step S904, the ASIC 202 compares the remaining ink amount value obtained in step S903 with a threshold INK_Low stored beforehand in the ASIC 202. As a result of the comparison, in a case where the ASIC 202 determines that the remaining ink amount value is less than or equal to the threshold INK_Low (NO in step S904), the processing proceeds to step S905. In step S905, the ASIC 202 notifies the user of the remaining ink amount being low. The notification is executed as turning-on of the LED or display on the LCD of the recording apparatus 100 based on an instruction from the ASIC 202 to the external UI device 217. After the remaining ink amount being low is notified to the user in step S905, the processing returns to step S901 to execute the remaining ink amount detection processing again.

In a case where the ASIC 202 determines that the remaining ink amount values is greater than the threshold INK_Low (YES in step S904), the processing proceeds to step S906. In step S906, the ASIC 202 notifies the user of the remaining ink amount.

The notification is also executed as turning-on of the LED or display on the LCD of the recording apparatus 100 based on an instruction from the ASIC 202 to the external UI device 217, as with the notification to the user in step S905. The external input device 200 may notify the user of the remaining ink amount information by receiving an instruction from the ASIC 202.

The external input device 200 may notify the user of the remaining ink amount in each of step S905 and step S906 by receiving an instruction from the ASIC 202. The notification by the external input device 200 and the notification by the external UI device 217 combined may be used.

A second exemplary embodiment will be described below, but a configuration similar to the configuration of the first exemplary embodiment described above will not be described.

As with the first exemplary embodiment, a remaining ink amount detection unit 216 according to the present exemplary embodiment has a configuration similar to the configuration illustrated in FIG. 8, and an electrostatic capacity detection substrate 803 and each of sensors 303a to 303n are connected via conducting wires 801a to 801n. An electrostatic capacity detected by an electrostatic capacity detection circuit 802 when a remaining ink amount of an ink tank 108a is detected is the sum of the electrostatic capacity of the sensor 303a and the electrostatic capacity of the conducting wire 801a.

Each of the conducting wires 801a to 801n has a length corresponding to a distance between the corresponding one of the ink tanks 108a to 108n and the electrostatic capacity detection substrate 803. A conducting wire R also has a length corresponding to a distance between a reference sensor 706 and the electrostatic capacity detection substrate 803, and thus, in a case where the lengths of the respective conducting wires 801a to 801n and the conducting wire R vary, the electrostatic capacities also vary. Further, the electrostatic capacities can also vary depending on conditions such as the thickness and material of each of the conducting wires 801a to 801n and the conducting wire R.

In a case where the remaining ink amount of the ink tank 108a is detected, correction processing using Formula 6 is executed in an ASIC 202 in a state where the electrostatic capacity of the conducting wire 801a and the electrostatic capacity of the conducting wire R are included as described above. In other words, the sum of the electrostatic capacity of the sensor 303a and the electrostatic capacity of the conducting wire 801a is detected as an electrostatic capacity C2, and the sum of the electrostatic capacity of the reference sensor 706 and the electrostatic capacity of the conducting wire R is detected as an electrostatic capacity Cref. The electrostatic capacity Cref is subtracted from the electrostatic capacity C2 in this state, and thus an error occurs by an amount corresponding to a difference between the electrostatic capacity of the conducting wire 801a and the electrostatic capacity of the conducting wire R.

Here, the electrostatic capacity of each of the conducting wire 801a and the conducting wire R is a known electrostatic capacity determined by the material and length of the conducting wire. Thus, the electrostatic capacity of each of the conducting wire 801a and the conducting wire R is stored beforehand in the ASIC 202, and the electrostatic capacity of each of the conducting wires is subtracted when the correction processing using Formula 6 is performed, so that the occurrence of the above-described error can be prevented. While the case where the remaining ink amount of the ink tank 108a is detected is described above, similar processing can be performed in a case where the remaining amount in each of the ink tanks 108b to 108n is detected. In other words, the electrostatic capacity of each of the conducting wires 801b to 801n and the electrostatic capacity of the conducting wire R are stored beforehand in the ASIC 202, so that the occurrence of the error by the electrostatic capacity of the conducting wire can be prevented.

If the error by the electrostatic capacity of the conducting wire is corrected in a case where the remaining ink amount of the ink tank 108a is detected, a correction formula is Formula 7, where the electrostatic capacity of the conducting wire R is CLR, and the electrostatic capacity of the conducting wire 801a is CLa.

C1=(C2−CLa)−(Cref−CLR)=((ϵ1−ϵ2)(S1/d)+ϵ2(S2/d)+Cex−CLa)−(Cref(S/Sref)−CLR) (Formula 7)

In a case where the remaining ink amount of each of the ink tanks 108b to 108n is detected, the correction processing using Formula 7 is also performed using the electrostatic capacity of each of the conducting wires 801b to 801n stored in the ASIC 202, so that the occurrence of a detection error by the electrostatic capacity of the conducting wire can be prevented.

In the present exemplary embodiment, the remaining ink amount detection is performed in a manner similar to the flowchart in FIG. 9 according to the first exemplary embodiment. However, in step S903, the ASIC 202 performs arithmetic processing according to the correction formula expressed as Formula 7. A value obtained by the arithmetic processing is a remaining ink amount value. In step S904 and subsequent steps, the processing is performed in a manner similar to the first exemplary embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2021-169110, filed Oct. 14, 2021, and No. 2022-151520, filed Sep. 22, 2022, which are hereby incorporated by reference herein in their entirety.

What is claimed is:

1. A recording apparatus comprising:
a storage unit configured to store a liquid or powder to be supplied to a recording portion configured to perform recording;
a first electrode positioned on an outer surface of the storage unit;
a second electrode positioned away from the storage unit; and
a circuit connected to each of the first electrode and the second electrode.

2. The recording apparatus according to claim 1, wherein, based on a result of detection by the first electrode and a result of detection by the second electrode, the recording apparatus detects an amount of the liquid or powder stored in the storage unit.

3. The recording apparatus according to claim 2, wherein the first electrode and the second electrode are connected via the circuit and a conducting wire.

4. The recording apparatus according to claim 3, wherein the recording apparatus detects the amount of the liquid or powder stored in the storage unit further based on information about an electrostatic capacity of the conducting wire.

5. The recording apparatus according to claim 2, wherein, based on a value obtained based on the result of detection by the first electrode and the result of detection by the second electrode, the recording apparatus provides a user with a notification indicating the amount of the liquid or powder stored in the storage unit.

6. The recording apparatus according to claim 5, further comprising a notification unit configured to provide the notification indicating the amount of the liquid or powder stored in the storage unit.

7. The recording apparatus according to claim 2, wherein, in a case where the recording apparatus compares a value obtained based on the result of detection by the first electrode and the result of detection by the second electrode with a predetermined threshold value, the recording apparatus provides a user with a notification indicating that the amount of the liquid or powder stored in the storage unit is small in a case where the recording apparatus determines that the obtained value is less than the predetermined threshold value.

8. The recording apparatus according to claim 7, further comprising a notification unit configured to provide the notification indicating that the amount of the liquid or powder stored in the storage unit is small.

9. The recording apparatus according to claim 1, wherein, based on a result of detection by the first electrode where the result is corrected based on a result of detection by the second electrode, the recording apparatus detects an amount of the liquid or powder stored in the storage unit.

10. The recording apparatus according to claim 9, wherein the first electrode and the second electrode are connected via the circuit and a conducting wire.

11. The recording apparatus according to claim 10, wherein, based on the result of detection by the first electrode where the result is corrected based on both the result of detection by the second electrode and information about an electrostatic capacity of the conducting wire, the recording apparatus detects the amount of the liquid or powder stored in the storage unit.

12. The recording apparatus according to claim 9, wherein, based on a value obtained based on the result of detection by the first electrode and the result of detection by the second electrode, the recording apparatus provides a user with a notification indicating the amount of the liquid or powder stored in the storage unit.

13. The recording apparatus according to claim 12, further comprising a notification unit configured to provide the notification indicating the amount of the liquid or powder stored in the storage unit.

14. The recording apparatus according to claim 9, wherein, in a case where the recording apparatus compares a value obtained based on the result of detection by the first electrode and the result of detection by the second electrode with a predetermined threshold value, the recording apparatus provides a user with a notification indicating that the amount of the liquid or powder stored in the storage unit is small in a case where the recording apparatus determines that the obtained value is less than the predetermined threshold value.

15. The recording apparatus according to claim 14, further comprising a notification unit configured to provide the notification indicating that the amount of the liquid or powder stored in the storage unit is small.

16. The recording apparatus according to claim 1, wherein the storage unit includes an introduction portion configured to receive introduction of the liquid or powder into the storage unit.

17. The recording apparatus according to claim 1, wherein the recording portion is configured to perform recording by ejecting ink to a recording medium.

18. The recording apparatus according to claim 1, wherein the second electrode is disposed on a rear face side of the storage unit and away from a rear face of the storage unit.

19. A method of controlling a recording apparatus having a storage unit configured to store a liquid or powder to be supplied to a recording portion configured to perform recording, a first electrode positioned on an outer surface of the storage unit, a second electrode positioned away from the storage unit, and a circuit connected to each of the first electrode and the second electrode, the method comprising:
performing first detection by the first electrode;
performing second detection by the second electrode; and
detecting an amount of the liquid or powder stored in the storage unit based on a result of the first detection and a result of the second detection.

20. A method of controlling a recording apparatus having a storage unit configured to store a liquid or powder to be supplied to a recording portion configured to perform recording, a first electrode positioned on an outer surface of the storage unit, a second electrode positioned away from the storage unit, and a circuit connected to each of the first electrode and the second electrode, the method comprising:
performing first detection by the first electrode;
performing second detection by the second electrode; and
detecting an amount of the liquid or powder stored in the storage unit based on a result of the first detection where the result is corrected based on a result of the second detection.
